(19) United States
(12) Patent Application Publication
(10) Pub. No.: US 2024/0092611 A1
(43) Pub. Date: Mar. 21, 2024

(54) MONITORING SYSTEM AND METHOD FOR MONITORING A PEOPLE CONVEYOR SYSTEM

(71) Applicant: KONE Corporation, Helsinki (FI)

(72) Inventors: Davide LA CROCE, HELSINKI (FI); Matti LAAKSO, HELSINKI (FI); Otto PEKANDER, HELSINKI (FI)

(73) Assignee: KONE Corporation, Helsinki (FI)

(21) Appl. No.: 18/524,580

(22) Filed: Nov. 30, 2023

Related U.S. Application Data
(63) Continuation of application No. PCT/EP2021/064996, filed on Jun. 4, 2021.

(51) Int. Cl. B66B 5/00; B66B 1/34; B66B 25/00

(52) U.S. Cl. CPC B66B 5/0018; B66B 1/3461; B66B 25/006; B66B 13/22

(57) ABSTRACT

The invention relates to a monitoring system for monitoring a people conveyor system. The monitoring system comprises a wireless mesh network comprising a plurality of node devices and one or more peripheral devices. A node device joining to the wireless mesh network is configured to: obtain connection data representing a connection of the node device to a peripheral device and assign itself a sink node role, if the obtained connection data indicates a connection to a gateway device, or otherwise provide the obtained connection data to the gateway device. The gateway device is configured to: assign an operation role to the node device based on the obtained connection data. The assigned role is: a sensor node role, if the obtained connection data indicates a connection to a people conveyor related sensor device, or a router node role, if the obtained connection data indicates that the node device is not connected to any peripheral device. The invention relates also to a people conveyor system and a method for monitoring a people conveyor system.

### TECHNICAL FIELD

The invention concerns in general the technical field of people conveyor systems. Especially the invention concerns monitoring of people conveyor systems.

### BACKGROUND

Typically, people conveyor related data may be obtained for example for remote maintenance and/or people conveyor usage monitoring purposes from internal buses and/or control units of the people conveyor system, such as an elevator system, an escalator system, or a moving walkway system. However, for example in case of third-party people conveyor systems, there may not be access to the internal buses and/or control units for obtaining the people conveyor related data for the monitoring purposes. A monitoring unit comprising one or more internal or external sensor devices may be arranged to the people conveyor system to obtain the people conveyor related data. For example, in case of the elevator system, the monitoring unit may be arranged to an elevator car travelling along an elevator shaft. However, it may not be possible to cover all failure cases with said monitoring unit. Moreover, especially in the elevator systems, where the monitoring unit is traveling on the elevator car along the elevator shaft, addition of one or more further sensor devices residing for example inside the elevator shaft and/or a machine room by simply wiring the sensor devices to the monitoring unit would be very expensive and sometimes even not possible.

Thus, there is need to develop further solutions to improve monitoring of a people conveyor system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a monitoring system, a method, and a people conveyor system for monitoring a people conveyor system. Another objective of the invention is that the monitoring system, the method, computer program, and a tangible non-volatile computer-readable medium for monitoring a people conveyor system improve at least partly monitoring of a people conveyor system.

The objectives of the invention are reached by a monitoring system, a method, and a people conveyor system as defined by the respective independent claims.

According to a first aspect, a monitoring system for monitoring a people conveyor system is provided, wherein the monitoring system comprises a wireless mesh network comprising a plurality of node devices and one or more peripheral devices of the people conveyor system, wherein a node device joining to the wireless mesh network is configured to: obtain connection data representing a connection of the node device to a peripheral device of the people conveyor system, and assign itself a sink node role, if the obtained connection data indicates a connection to a gateway device, wherein the gateway device is arranged to the people conveyor system, or otherwise provide the obtained connection data to the gateway device, wherein the gateway device is configured to: assign an operation role to the node device based on the obtained connection data, wherein the assigned role is: a sensor node role, if the obtained connection data indicates a connection to a people conveyor related sensor device, wherein the people conveyor related sensor device is configured to obtain sensor data representing condition of the people conveyor system; or a router node role, if the obtained connection data indicates that the node device is not connected to any peripheral device of the people conveyor system.

After the assigning the sensor node role to the node device, the gateway device may further be configured to: determine a type of the people conveyor related sensor device to which the node device is connected, and obtain via a wireless update system an application software corresponding to the determined type of the people conveyor related sensor device to which the node device is connected.

The connection of the node device to the gateway device indicated by the obtained connection data may be provided via a first type serial port connection, wherein the first type serial port connection may be a Universal Serial Bus (USB) connection.

Alternatively or in addition the connection of the node device 102, 102b) to the people conveyor related sensor device indicated by the obtained connection data may be provided via a second type serial port connection, wherein the second type serial port connection may be an analog connection, a RS-232 connection, a RS-485 connection, an Inter-Integrated Circuit (I²C) connection, and/or a Serial Peripheral Interface (SPI) connection.

The node device may be configured to obtain the connection data by scanning one or more communication interfaces of the node device.

The canning may comprise at least obtaining connection data via the one or more communication interface of the node device.

Alternatively or in addition, the scanning may comprise providing request data via the one or more communication interfaces and obtaining the connection data via the one or more communication interfaces of the node device in response to the providing the request data.

Alternatively, the node device may be configured to obtain the connection data as a user input.

The people conveyor related sensor device may comprise a hydraulic sensor device, a door sensor device, a water presence sensor device, a light level sensor device, a human presence sensor device, a vibrating sensor device, a temperature sensor device, an energy meter device, or a universal asynchronous receiver-transmitter (UART) device.

The people conveyor system may be an elevator system, an escalator system, or a moving walkway system.

According to a second aspect, a method for monitoring a people conveyor system is provided, wherein the method comprises: obtaining connection data representing a connection of a node device joining to a wireless mesh network to a peripheral device of the people conveyor system, and assigning an operation role based on the obtained connection data, wherein the assigned role is: a sink node role, if the obtained connection data indicates a connection to a gateway device, wherein the gateway device is arranged to the people conveyor system; a sensor node role, if the obtained connection data indicates a connection to a people conveyor related sensor device, wherein the people conveyor related sensor device is configured to obtain sensor data representing condition of the people conveyor system; or a router node role, if the obtained connection data indicates that the node device is not connected to any peripheral device of the people conveyor system.

After the assigning of the sensor node role, the method may further comprise: determining a type of the people conveyor related sensor device to which the node device is connected, and obtaining via a wireless update system an application software corresponding to the type of the people conveyor related sensor device to which the node device is connected.

The connection of the node device to the gateway device indicated by the obtained connection data may be provided via a first type serial port connection, wherein the first type serial port connection may be a Universal Serial Bus (USB) connection.

Alternatively or in addition, the connection of the node device to the people conveyor related sensor device indicated by the obtained connection data may be provided via a second type serial port connection, wherein the second type serial port connection may be an analog connection, a RS-232 connection, RS-485 connection, Inter-Integrated Circuit (I²C) connection, and/or Serial Peripheral Interface (SPI) connection.

The connection data may be obtained by scanning one or more communication interfaces of the node device.

The scanning may comprise at least obtaining connection data via the one or more communication interface of the node device.

Alternatively or in addition, the scanning may comprise providing request data via the one or more communication interfaces and obtaining the connection data via the one or more communication interfaces of the node device in response to the providing the request data.

Alternatively, the connection data may be obtained as a user input.

The people conveyor related sensor device may comprise a hydraulic sensor device, a door sensor device, a water presence sensor device, a light level sensor device, a human presence sensor device, a vibrating sensor device, a temperature sensor device, an energy meter device, or a universal asynchronous receiver-transmitter (UART) device.

The people conveyor system may be an elevator system, an escalator system, or a moving walkway system.

According to a third aspect, a people conveyor system is provided, wherein the people conveyor system comprises the monitoring system described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a monitoring system for monitoring a people conveyor system.

FIGS. 2A-2C illustrate schematically examples of a people conveyor system.

FIG. 3 illustrates schematically an example of a method for monitoring a people conveyor system.

FIG. 4 illustrates schematically another example of a method for monitoring a people conveyor system.

FIG. 5 illustrates schematically yet another example of a method for monitoring a people conveyor system.

FIG. 6 illustrates schematically an example of components of a node device.

FIG. 7 illustrates schematically an example of components of a gateway device.

### DESCRIPTION OF THE EXEMPLIFYING EMBODIMENTS

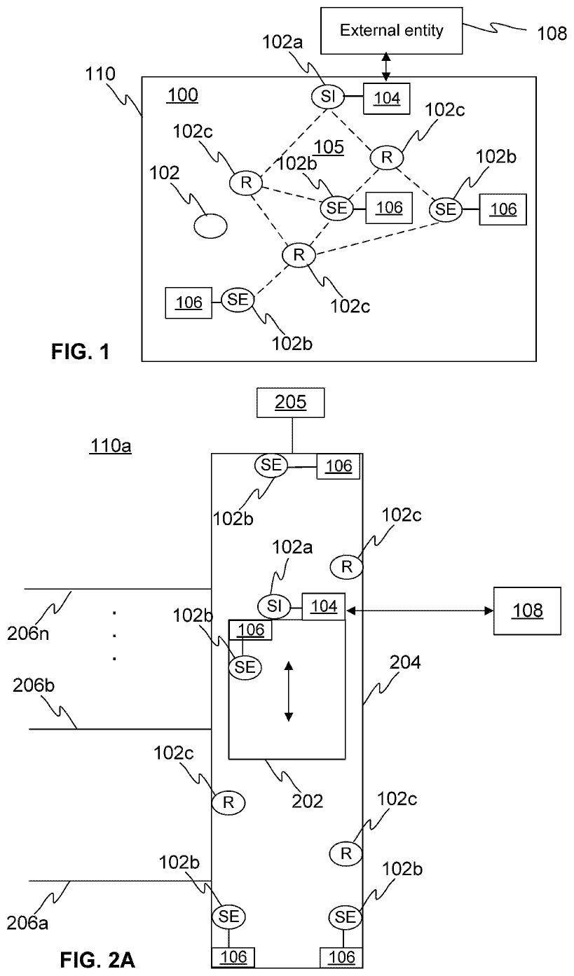

FIG. 1 illustrates schematically an example of a monitoring system 100 for monitoring a people conveyor system 110. The monitoring system 100 comprises a wireless mesh network 105 comprising a plurality of node devices 102a-102c. The monitoring system 100 further comprises one or more peripheral devices 104, 106 of the people conveyor system 110. Each node device 102a-102c forming the wireless mesh network 105 may be configured to operate either in a sink node role, a sensor node role, or a router node role depending on whether the node device 102a-102c is connected to one peripheral device 104, 106 of the people conveyor system 110 and/or a type of the peripheral device 104, 106 to which the node device 102a-102c is connected. The one or more peripheral devices 104, 106 may comprise at least one gateway device 104 and/or one or more people conveyor related sensor devices 106. If the node device 102a-102c is connected to the gateway device 104, the node device 102a is configured to operate in the sink node role. Alternatively, if the node device 102a-102c is connected to the people conveyor related sensor device 106, the node device 102b is configured to operate in the sensor node role. Alternatively, if the node device 102a-102c is not connected to any peripheral device 104, 106, the node device 102c is configured to operate in router node role. In the example monitoring system 100 of FIG. 1 the node device 102a is connected to the gateway device 104. Thus, the node device 102a is configured to operate in the sink node role. Furthermore, in the example monitoring system 100 of FIG. 1 the node devices 102b are connected to the people conveyor related sensor devices 106. Thus, the node devices 102b are configured to operate in the sensor node role. Furthermore, in the example monitoring system 100 of FIG. 1 the node devices 102c are not connected to any peripheral device 104, 106. Thus, the node devices 102c are configured to operate in the router node role. In the example of FIG. 1, the dashed lines between the plurality of node devices 102a-102c illustrate communication between the plurality of node devices 102a-102c of the wireless mesh network 105. The communication between the plurality of node devices 102a-102c of the wireless mesh network 105 may be bi-directional. In the example of FIG. 1, the solid lines between the node devices 102a, 102b and the peripheral devices 104, 106 of the people conveyor system 110 illustrates the connection of the node devices 102a, 102b to the peripheral devices 104, 106.

The example of FIG. 1 illustrates further one node device 102 that is not at least yet joined or is going to join the wireless mesh network 105 of the monitoring system 100. As mentioned, each node device 102 is capable of operating in the sink node role, the sensor node role, and router node role. However, before each node device 102 has joined the wireless mesh network 105, said node device 102 is not aware of its operation mode. For each node device 102 an operation role may be assigned, when the node device 102 joins the wireless mesh network 105 as will be described later in this application.

The people conveyor system 110 may be an elevator system 110a, an escalator system 110b, or a moving walkway system 110c. In other words, the monitoring system 100 may be used for monitoring the elevator system 110a, the escalator system 110b, or the moving walkway system 110c. The people conveyor system 110, 110a-110c may comprise at least the monitoring system 100.

The one or more people conveyor related sensor devices 106 may be configured to obtain sensor data representing condition of the people conveyor system 110, 110a-110c. The people conveyor related sensor device 106 may comprise for example, but not limited to, a hydraulic sensor device, a door sensor device, a water presence sensor device, a light level sensor device, a human presence sensor device, a vibrating sensor device, an energy meter device, a temperature sensor device, or a universal asynchronous receiver-transmitter (UART) device. Alternatively or in addition, the people conveyor related sensor device 106 may be a Modbus-based device. The one or more people conveyor related sensor devices 106 may be arranged to different locations within the people conveyor system 110, 110a-110c as will be described later in this application. The one or more people conveyor related sensor devices 106 may comprise e.g. one or more elevator related sensor devices, one or more escalator related sensor devices, or one or more moving walkway related sensor devices depending on the people conveyor system 110, 110a-110c in question.

The wireless mesh network 105 may relay messages by a node device 102a-102c to a node device 102a-102c until the message reaches the node device 102a-102c to which the message is intended. The messages may comprise data, e.g. the sensor data obtained by the one or more people conveyor related sensor devices 106 as will be described later. At least the node devices 102c operating in the router node role are configured to participate in the relaying the messages. Each of the plurality of node devices 102a-102c may comprise a communication interface unit 630 for providing one or more communication interfaces for communication with any other unit, e.g. the one or more peripheral devices 104, 106, one or more other node devices 102a-102c of the wireless mesh network 105, and/or any other units. The communication interface unit 630 of each node device 102a-102c may comprise one or more communication devices e.g. at least one radio transceiver, at least one antenna, at least one communication port, etc. The communication between the plurality of node devices 102a-102c of the wireless mesh network 105 may be based on at least one short-range wireless radio technology. The at least one short-range wireless radio technology may comprise e.g., but is not limited to, Bluetooth (e.g. Bluetooth low energy (BLE)), and/or Zigbee. Each of the plurality of node devices 102a-102c may be configured to receive and transmit the messages from and to other node devices 102a-102c of the wireless mesh network 105. The communication between the node devices 102a, 102b operating in the sink node role and/or in the sensor node role and the one or more peripheral device 104, 106 of the people conveyor system 110 may be based on one or more known wired communication technologies as will be described later in this application.

The at least one gateway device 104 is arranged to the people conveyor system 110. For example, if the people conveyor system 110 is the elevator system 110a, the gateway device 104 may be arranged to an elevator car 202, e.g. to a rooftop of the elevator car 202 or a machine room. Alternatively, if the people conveyor system 110 is the escalator system 110b or the moving walkway system 110c, the gateway device 104 may be arranged to one of the platforms of the escalator system 110b or the moving walkway system 110c. The at least one gateway device 104 may operate as a gateway between the wireless mesh network 105 and at least one external entity 108. In other words, the at least one gateway device 104 may be configured to provide data, e.g. the sensor data obtained by the one or more people conveyor related sensor devices 106, from the wireless mesh network 105 to the at least one external entity 108 and/or from the at least one external entity 108 to the wireless mesh network 105. For example, the sensor data obtained by the one or more people conveyor related sensor devices 106 may be relayed, e.g. routed, via the wireless mesh network 105 to the at least one gateway device 104, which provides the relayed sensor data to the at least one external entity 108.

According to another example, the at least one gateway device 104 may receive data from the at least one external entity 108 and provide the received data to one or more node devices 102a-102c of the wireless mesh network 105. The at least one external entity 108 may be e.g. a cloud server, an Internet of Things (IoT) platform, a service center, a maintenance center, a data center, and/or a control system 205, 215, 225 of the people conveyor system 110. The at least one gateway device 104 and the at least one external entity 108 may be communicatively coupled to each other. The communication between the at least one gateway device 104 and the at least one external entity 108 may be based on one or more known communication technologies, either wired or wireless.

The monitoring system 100 enables especially monitoring of third-party people conveyor systems 110, 110-110c, where there may not be access to internal buses and/or control units of the people conveyor system 110, 110a-110c. The monitoring system 100 enables monitoring the sensor data representing condition of the people conveyor system 110, 110a-110c obtained by the one or more people conveyor related sensor devices 106, which is especially beneficial in the case of the third-party people conveyor systems 110, 110-110c.

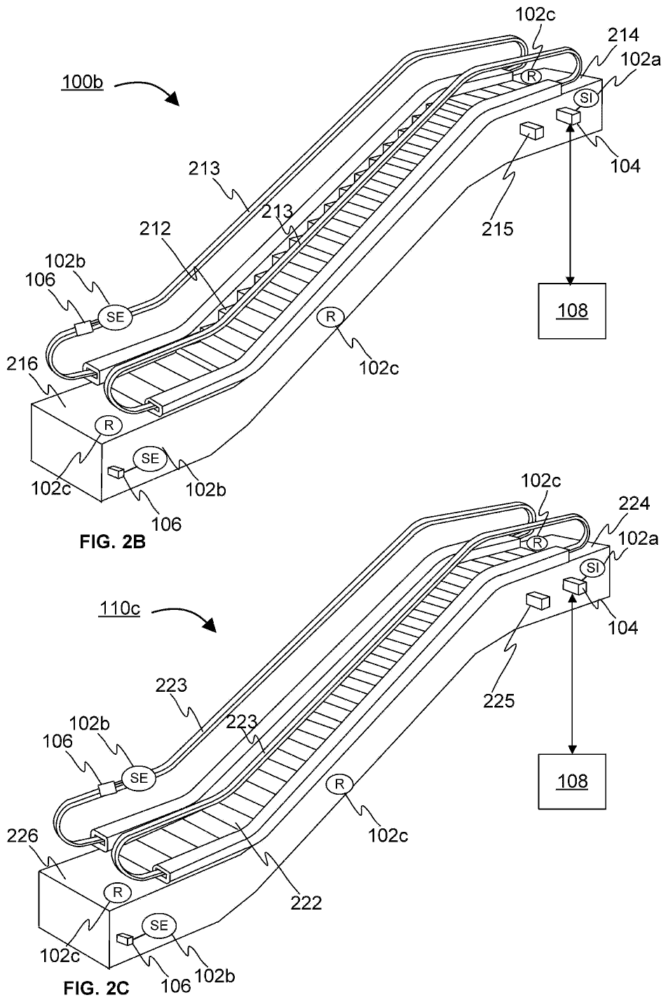

FIGS. 2A-2C illustrate schematically non-limiting examples of the people conveyor system 110, 110a-110c. For sake of clarity, any node devices 102 that are not at least yet joined or are going to join the wireless mesh network of the monitoring system 100 are not illustrated in FIGS. 2A-2C. Moreover, for sake of clarity the communication between the plurality of node devices 102a-102c forming the wireless mesh network 105 is not illustrated in FIGS. 2A-2C.

In the example of FIG. 2A the people conveyor system 110, 110a-110c is an elevator system 110a. The elevator system 110a comprises at least one elevator car 202 configured to travel along a respective at least one elevator shaft 204 between a plurality of landings 206a-206n and an elevator control system, e.g. an elevator control unit, 205. The elevator system 110a of the example of FIG. 2A comprises one elevator car 202 travelling along one elevator shaft 204, however the elevator system 110a may also comprise an elevator group, i.e. group of two or more elevator cars 202a each travelling along a separate elevator shaft 204 configured to operate as a unit serving the same landings 206a-206n. The elevator control system 205 may be configured to control the operation of the elevator system 110a at least in part. The elevator control system 205 may reside e.g. in a machine room (for sake of the clarity not shown in FIG. 2A) or in one of the landings 206a-206n of the elevator system 110a. The elevator system 110a may further comprise one or more other known elevator related entities, e.g. hoisting system, user interface devices, safety circuit and devices, elevator door system, etc., which are not shown in FIG. 2A for sake of clarity.

Next example locations of the plurality of node devices 102a-102c of the wireless mesh network 105 and the one or more peripheral devices 104, 106 are discussed, when the people conveyor system 110 is the elevator system 110a. As discussed above, the gateway device 104 may be arranged to the elevator car 202, e.g. on the rooftop of the elevator car 202 as illustrated in the example of FIG. 2A. Alternatively, the gateway device 104 may be arranged to the machine room. One node device 102a operating in the sink node role may be connected to the gateway device 104. If the elevator system 110a comprises more than one elevator car 202, one gateway device 104 may be arranged to each elevator car 202. In addition, the one or more elevator related sensor devices 106 may be arranged to different locations within the elevator system 110a. The one or more elevator related sensor devices 106 may be arranged for example, but not limited, to the elevator shaft, to the elevator car 202, and/or to the plurality landings 206a-206n. One node device 102b operating in the sensor node role may be connected to each of the one or more elevator related sensor devices 106. In the example of FIG. 2A one elevator related sensor device 106 is arranged to the elevator car 202 and one node device 102b operating in the sensor node role is connected to said elevator related sensor device 106. In addition, in the example of FIG. 2A three elevator related sensor devices 106 are arranged inside the elevator shaft so that one elevator related sensor device 106 is arranged to the top end of the elevator shaft 204 and two elevator relates sensor devices 106 are arranged to the bottom end of the elevator shaft 204, i.e. to a pit of the elevator shaft 204, and one node device 102b operating in the sensor node role is connected to each of the three elevator related sensor devices 106. Thus, the example wireless mesh network 105 of FIG. 2A comprises four node devices 102b operating in the sensor node role and each of the four node device 102b is connected to one elevator related sensor device 106. According to a non-limiting example the one or more elevator related sensor devices 106 may comprise at least one hydraulic sensor device arranged to the pit of the elevator shaft 204, at least one door sensor device arranged to a door of the elevator car 202, at least one water presence sensor device arranged to the pit of the elevator shaft 204, at least one light level sensor device arranged inside the elevator car 202, and/or at least one human presence sensor device arranged inside the elevator car 202 and/or inside the machine room. One or more node devices 102c operating in the router node role, i.e. one or more node devices 102c not connected to any peripheral device 104, 106 may be arranged to different locations within the elevator system 110a. The one or more node devices 102c operating in the router node role may be arranged for example, but not limited, to the elevator shaft 204, to the elevator car 202, and/or to the plurality landings 206a-206n. In the example of FIG. 2A four node devices 102c operating in the router node role are arranged inside the elevator shaft 204. As mentioned, FIG. 2A illustrates only non-limiting examples of the one or more peripheral devices 104, 106 and the plurality of node devices 102a-102c, when the people conveyor system 110 is the elevator system 110a, but the monitoring system 100 may comprise any other number of peripheral devises 104, 106 and/or the monitoring system 100 may comprise any other number of node devices 102a-102c arranged to any locations of the elevator system 110a.

In the example of FIG. 2B the people conveyor system 110 is an escalator system 110b. The escalator system 110b comprises a conveying entity 212 comprising steps arranged to an endless track, and an escalator control system, e.g. an escalator control unit, 215. The escalator control system 215 may be configured to control the operation of the escalator system 110b at least in part. The escalator control system 215 may for example be arranged to one of the platforms 214, 216 of the escalator system 110b. In the example of FIG. 2B the escalator control system 215 is arranged to a first platform, i.e. a top platform, 214 of the escalator system 110b. Alternatively, the escalator control system 215 may be arranged for example to a second platform, i.e. a bottom platform, 216 of the escalator system 110b. The escalator system 100b may further comprise one or more other known escalator related entities, e.g. a driving machine, etc., which are not shown in FIG. 2B for sake of clarity.

Next example locations of the plurality of node devices 102a-102c of the wireless mesh network 105 and the one or more peripheral devices 104, 106 are discussed, when the people conveyor system 110 is the escalator system 110b. As discussed above, the at least one gateway device 104 may be arranged to at least one platform 214, 216 of the escalator system 110b. In the example of FIG. 2B the gateway device 104 is arranged to the first platform 214 of the escalator system 110b. One node device 102a operating in the sink node role may be connected to the gateway device 104. In addition, the one or more escalator related sensor devices 106 may be arranged to different locations within the escalator system 110b. The one or more escalator related sensor devices 106 may be arranged for example, but not limited, to the at least one platform 214, 216 of the escalator system 110b, to at least one handrail 213 of the escalator system 110b, to a gear box of the escalator system 110b, and/or to conveying entity 212 of the escalator system 110b. One node device 102b operating in the sensor node role may be connected to each of the one or more escalator related sensor devices 106. In the example of FIG. 2B one escalator related sensor device 106 is arranged to a handrail 213 of the escalator system 110b and one node device 102b operating in the sensor node role is connected to said escalator related sensor device 106. In addition, in the example of FIG. 2B one escalator related sensor device 106 is arranged to the second platform 216 of the escalator system 110b and one node device 102b operating in the sensor node role is connected to said escalator related sensor device 106. Thus, the example wireless mesh network 105 of FIG. 2B comprises two node devices 102b operating in the sensor node role and each of the two node devices 102b is connected to one escalator related sensor device 106. According to a non-limiting example the one or more escalator related sensor devices 106 may comprise at least one human presence sensor device arranged to the escalator system 110b, at least one vibration sensor device arranged for example to a gear box (for sake of clarity not shown in FIG. 2B) of the escalator system 110b, and/or at least one temperature sensor arranged to the gear box of the escalator system 110b and/or to at least one handrail 213 of the escalator system 110b. One or more node devices 102c operating in the router node role, i.e. one or more node devices 102c not connected to any peripheral device 104, 106, may be arranged to different locations of the escalator system 110b. The one or more node devices 102c operating in the router node role may be arranged for example, but not limited, to the at least one platform 214, 216 of the escalator system 110b, to at the least one handrail 213 of the escalator system 110b, to the gear box of the escalator system 110b, and/or to the conveying entity 212 of the escalator system 110b. In the example of FIG. 2B three node devices 102c operating in the router node role are arranged to different locations within the escalator system 110b. As mentioned, FIG. 2B illustrates only non-limiting examples of the one or more peripheral devices 104, 106 and the plurality of node devices 102a-102c, when the people conveyor system 110 is the escalator system 110b, but the monitoring system 100 may comprise any other number of peripheral devises 104, 106 and/or the monitoring system 100 may comprise any other number of node devices 102a-102c arranged to any locations of the escalator system 110b.

In the example of FIG. 2C the people conveyor system 110 is a moving walkway system 110c. The moving walkway system 110c comprises a conveying entity 222 comprising pallets arranged to an endless track, and a moving walkway control system, e.g. an moving walkway control unit, 225. The moving walkway control system 225 may be configured to control the operation of the moving walkway system 110c at least in part. The moving walkway control system 225 may for example be arranged to one of platforms 224, 226 of the moving walkway system 110c. In the example of FIG. 2C the moving walkway control system 225 is arranged to a first platform, e.g. a top platform, 224 of the moving walkway system 110c. Alternatively, the moving walkway control system 225 may be arranged for example to a second platform, e.g. a bottom platform, 226 of the moving walkway system 110c. In the example of FIG. 2C the moving walkway system 110c is an inclined moving walkway system, i.e. a moving walkway system configured to convey people or load across an inclined plane, e.g. between two floors. However, the moving walkway system 110c may also be a horizontal moving walkway system, i.e. a moving walkway system configured to convey people or load across a horizontal plane. The moving walkway system 110c may further comprise one or more other known moving walkway related entities, e.g. a driving machine, etc., which are not shown in FIG. 2C for sake of clarity.

Next example locations of the plurality of node devices 102a-102c of the wireless mesh network 105 and the one or more peripheral devices 104, 106 are discussed, when the people conveyor system 110 is the moving walkway system 110c. As discussed above, the at least one gateway device 104 may be arranged to the at least one platform 224, 226 of the moving walkway system 110c. In the example of FIG. 2C the gateway device 104 is arranged to the first platform 224 of the moving walkway system 110c. One node device 102a operating in the sink node role may be connected to the gateway device 104. In addition, one or more moving walkway related sensor devices 106 may be arranged different locations within the moving walkway system 110c. The one or more moving walkway related sensor devices 106 may be arranged for example, but not limited, to the at least one platform 224, 226 of the moving walkway system 110c, to at least one handrail 223 of the moving walkway system 110c, to a gear box of the moving walkway system 110c, and/or to conveying entity 222 of the moving walkway system 110c. One node device 102b operating in the sensor node role may be connected to each of the one or more moving walkway related sensor devices 106. In the example of FIG. 2C one moving walkway related sensor device 106 is arranged to a handrail 223 of the moving walkway system 110c and one node device 102b operating in the sensor node role is connected to said moving walkway related sensor device 106. In addition, in the example of FIG. 2C one moving walkway related sensor device 106 is arranged to the second platform 226 of the moving walkway system 110c and one node device 102b operating in the sensor node role is connected to said moving walkway related sensor device 106. Thus, the example wireless mesh network 105 of FIG. 2C comprises two node devices 102b operating in the sensor node role and each of the two node devices 102b is connected to one moving walkway related sensor device 106. According to a non-limiting example the one or more moving walkway related sensor devices 106 may comprise at least one human presence sensor device arranged to the moving walkway system 110c, at least one vibration sensor device arranged for example to a gear box (for sake of clarity not shown in FIG. 2C) of the moving walkway system 110c, and/or at least one temperature sensor arranged to the gear box of the moving walkway system 110c and/or to at least one handrail 223 of the moving walkway system 110c. One or more node devices 102c operating in the router node role, i.e. one or more node devices 102c not connected to any peripheral device 104, 106, may be arranged to different locations of the moving walkway system 110c. The one or more node devices 102c operating in the router node role may be arranged for example, but not limited, to the at least one platform 224, 226 of the moving walkway system 110c, to the at least one handrail 223 of the moving walkway system 110c, to the gear box of the moving walkway system 110c, and/or to the conveying entity 222 of the moving walkway system 110b. In the example of FIG. 2C three node devices 102c operating in the router node role are arranged to different locations within the moving walkway system 110c. As mentioned, FIG. 2C illustrates only non-limiting examples of the one or more peripheral devices 104, 106 and the plurality of node devices 102a-102c, when the people conveyor system 110 is the moving walkway system 110c, but the monitoring system 100 may comprise any other number of peripheral devises 104, 106 and/or the monitoring system 100 may comprise any other number of node devices 102a-102c arranged to any locations of the moving walkway system 110c.

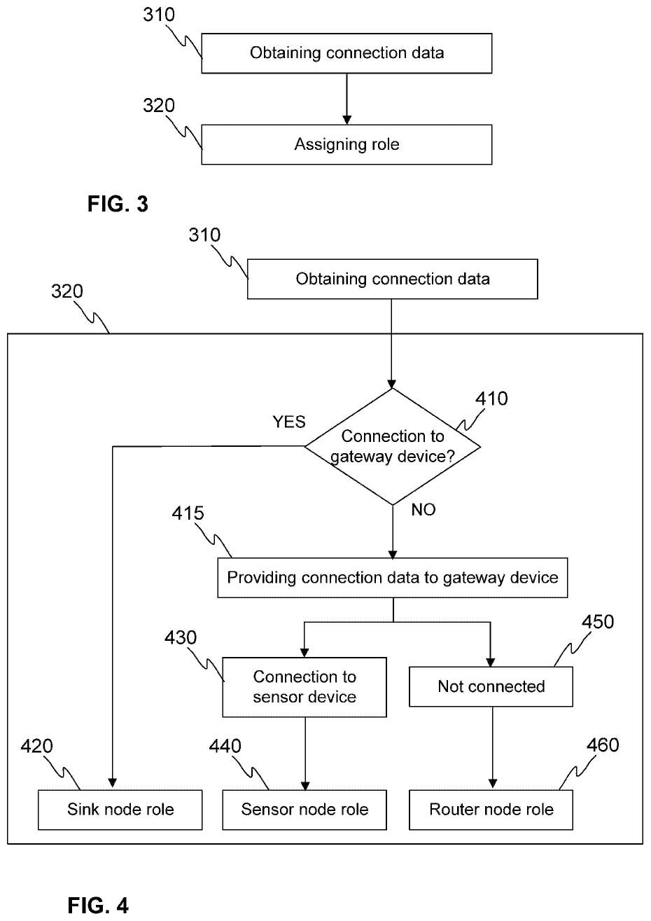

Now, at least some aspects of the present invention are described by referring to FIG. 3 in which an example of a method for monitoring a people conveyor system 110, 110a-110c. FIG. 3 schematically illustrates the example method as a flow chart. The method is described referring to one node device 102 that is joining the wireless mesh network 105 and one gateway device 104 arranged to the people conveyor system 110, 110a-110c. However, each node device 102 joining to the wireless mesh network 105 may independently perform the method steps relating to one or more operations of the node device 102. As mentioned, each node device 102 is capable of operating in the sink node 102a role, the sensor node 102b role, and router node 102c role. Moreover, before each node device 102 has joined the wireless mesh network 105, said node device 102 is not aware of its operation mode. In other words, each node device 102 may be a generic node device, e.g. generic radio dongle. Thus, when each node device 102 is joining the wireless mesh network 105, said node device 102 and/or the gateway device 104 may perform at least some of the following method steps to assign an operation role for the node device 102. Before performing the role assignment, the node device 102 joining the wireless mesh network 105 may obtain network configuration information, e.g. by receiving a BLE beacon message, from one or more node devices 102a-102c of the wireless mesh network 105 to be able to join the wireless mesh network 105, i.e. to operate as a part of, i.e. belong to, the wireless mesh network 105 of the monitoring system 100. The node device 102 joining to the wireless mesh network 105 may be for example, a new node device 102 or a node device 102 replacing an existing node device 102a-102c, e.g. a faulty node device. According to an example, if a new peripheral device 104, 106 is installed to the people conveyor system 110, a new node device 102 may be connected to the new peripheral device 104, 106 and joined to the wireless mesh network 105 as will be discussed.

At a step 310, the node device 102 joining to the wireless mesh network 105 obtains connection data representing a connection of the node device 102 to the peripheral device 104, 106 of the people conveyor system 110, 110a-110c. The node device 102 may obtain the connection data by scanning, i.e. probing, the one or more communication interfaces, i.e. connection interfaces, of the node device 102 as will be described later. Alternatively, the node device 102 may obtain the connection data as a user input via a user interface (UI) unit 640. The connection data representing the connection of the node device 102 may for example comprise information of a possible connection of the node device 102 to the peripheral device 104, 106 and/or identification information of the peripheral device 104, 106 connected to the node device 102, if the node device 102 is connected to the peripheral device 104, 106.

At a step 320, a role, i.e. an operation role to the node device 102 joining to the wireless mesh network 105 is assigned based on the obtained connection data. In other words, at the step 320 operation role to the node device 102 joining to the wireless mesh network 105 is assigned in response to obtaining the connection data. Depending on the obtained connection data the node device 102 may itself assign the operation role to itself and/or the gateway device 104 may assign the operation role to the node device 102. After the assigning of the operation role at the step 320, the node device 102 may provide a role assignment message indicating the role assignment of said node device 102 to the gateway device 104 via the wireless mesh network 105. In response to receiving the role assignment message from the node device 102, the gateway device 104 may provide an acknowledgement message to the node device 102 via the wireless mesh network 105. Alternatively, the gateway device 104 may forward the role assignment message to the at least one external entity 108, e.g. cloud server, and the at least one external entity 108 may provide the acknowledgement message to the node device 102 via the wireless mesh network 105 in response to receiving the role assignment message. Depending on the assigned role of the node device 102, the node device 102 may alternatively or in addition perform one or more other operations after the assigning of the operation role at the step 320 as will be descried.

FIG. 4 schematically discloses the flow chart of FIG. 3 in more detailed manner. Especially the step 320 becomes clear from FIG. 4. As said, the step 320 the operation role to the node device 102 joining to the wireless mesh network 105 is assigned based on the obtained connection data. If the obtained connection data indicates at a step 410 a connection to the gateway device 104, the assigned role of said node device 102 is the sink node 102a role at a step 420. In other words, if the obtained connection data indicates at the step 410 that the node device 102 is connected to the gateway device 104, the node device 102 assigns at the step 420 itself to the sink node 102a role. The connection of the node device 102, 102a to the gateway device 104 indicated by the obtained connection data may be provided via a first type serial port connection between the node device 102 and the gateway device 104. The first type serial port connection may be a Universal Serial Bus (USB) connection. In other words, if the obtained connection data indicates at the step 410 that the node device 102 is connected to the peripheral device 104 via the first type serial port connection, i.e. the USB connection, the peripheral device 104 to which the node device 102 is connected is the gateway device 104 and the node device 102 assigns at the step 420 itself to the sink node 102a role. Otherwise, i.e. if the obtained connection data does not indicate at the step 410 connection to the gateway device 104, the node device 102 provides the obtained connection data to the gateway device 104 at the step 415. If the obtained connection data indicates at as step 430 a connection to a people conveyor related sensor device 106, the assigned role of said node device 102 is the sensor node 102b role 440. In other words, if the obtained connection data indicates at the step 430 that the node device 102 is connected to the people conveyor related sensor device 106, the gateway device 104 assigns 440 to the node device 102 the sensor node 102b role. The connection of the node device 102, 102b to the people conveyor related sensor device 106 indicated by the obtained connection data may be provided via a second type serial port connection. The second type serial port connection may for example be, but is not limited to, an analog connection, a RS-232 connection, a RS-485 connection, an Inter-Integrated Circuit (I²C) connection, and/or a Serial Peripheral Interface (SPI) connection. In other words, if the obtained connection data indicates 430 that the node device 102 is connected to the peripheral device 106 via the second type serial port connection, the peripheral device 106 to which the node device 102 is connected is the people conveyor related sensor device 106 and the gateway device 104 assigns at the step 440 to the node device 102 the sensor node 102b role. According to a non-limiting example, some temperature sensor devices may be connected to the node devices via I²C connection. According to another non-limiting example, UART devices, Modbus-based devices, some energy meter devices, some temperature sensor devices, etc. may for example be connected to the node devices via RS485 connection. According to yet another non-limiting example, some temperature sensor devices may be connected to the node devices via analog connection. Alternatively, if the obtained connection data indicates at a step 450 that the node device 102 is not connected to any peripheral device 104, 106, the assigned role of said node device 102 is the router node 102c role 460. In other words, if the obtained connection data indicates 450 that the node device 102 is not connected to any peripheral device 104, 106, the gateway device 104 assigns 460 to the node device 102 the router node 102c role. After the assigning the operation role of the node device 102 at the step 440 or at the step 460, the gateway device 104 may further inform the node device 102 of the assigned operation role, e.g. the sensor node 102b role or the router node 102c role.

As discussed above, the node device 102 may obtain the connection data by scanning, i.e. probing, the one or more communication interfaces, i.e. connection interfaces, of the node device 102. In other words, the node device 102 may scan the one or more communication interfaces of the node device 102 one after another to obtain the connection data. According to an example, the node device 102 may perform the scanning in response to receiving a scan command from the gateway device 104. The scanning may comprise passive scanning and/or active scanning the one or more communication interfaces of the node device 102. The passive scanning may comprise obtaining connection data via the one or more communication interfaces of the node device 102. The active scanning may comprise providing, i.e. inputting, request data via the one or more communication interfaces of the node device 102 and obtaining the connection data via the one or more communication interface of the node device 102 in response to the provided request data. The request data may comprise generic request data, port specific request data, and/or device specific request data. As discussed above, the obtained connection data may for example comprise information representing a possible connection of the node device 102 to the peripheral device 104, 106 and/or identification information enabling identification of the peripheral device 104, 106 connected to the node device 102, if the node device 102 is connected to the peripheral device 104, 106. The used type of scanning (i.e. passive and/or active) may be dependent on the connection type and/or the type of peripheral device 104, 106 connected to the node device 102.

According to an example, the passive scanning may be used to define whether the node device 102 is connected to the gateway device 104. In other words, the node device 102 may use the passive scanning to obtain connection data indicating that the node device 102 is connected to the gateway device 104 via the first type serial port connection, i.e. the USB connection.

According to another example, the passive scanning may be used to define whether the node device 102 is connected to one or more people conveyor related sensor devices 106 via the analog connection or the I²C connection. In other words, the node device 102 may use the passive scanning to obtain connection data indicating that the node device 102 is connected to the people conveyor related sensor device 106 via the analog connection or the I²C connection. The node device 102 may for example record analog connection, e.g. analog pins, to obtain the connection data via the analog connection. For example, many temperature sensor devices connected to the node device 102 via the analog connection may have a half supply bias that depends on the type of the temperature sensor device, which may be used as the identification information enabling the identification of the peripheral device 104, 106 connected to the node device 102. Alternatively or in addition, the node device 102 may for example wait for acknowledgement (ACK) response via I²C connection, e.g. I²C bus, as the connection data.

According to yet another example, the active scanning may be used to define whether the node device 102 is connected to the people conveyor related sensor device 106 via the RS-485 connection or the SPI port connection. In other words, the node device 102 may use the active scanning to obtain connection data indicating that the node device 102 is connected to the people conveyor related sensor device 106 via the RS-485 connection or the SPI connection. The node device 102 may for example input request data, e.g. device specific data or RS-485 port specific request data, via the RS-485 connection, e.g. RS485 bus, and obtain the connection data via the RS-485 connection in response to the inputted request data. Alternatively or in addition, the node device 102 may for example input request data, e.g. device specific data or SPI port specific request data, via the SPI connection, e.g. SPI bus, and obtain the connection data via the SPI connection in response to the inputted request data.

According to an example, the scanning may comprise scanning the one or more communication interfaces of the node device 102 in a predefined sequence. The predefined sequence may be defined by the node device 102 itself or by the gateway device 104. If the predefined sequence is defined by the gateway device 104, the predefined sequence may be comprised in the scan command generated to the node device 102 to perform the scanning in said predefined sequence. The predefined sequence may comprise all of the one or more communication interfaces of the node device 102. Alternatively, the predefined sequence may comprise at least some of the one or more communication interfaces of the node device 102. According to a non-limiting example, the sequence may be, but is not limited to, the USB connection, the RS-485 connection, the analog connection, the I²C connection, and the SPI connection. In other words, the node device 102 may first scan the USB connection, then the RS-485 connection, and so on.

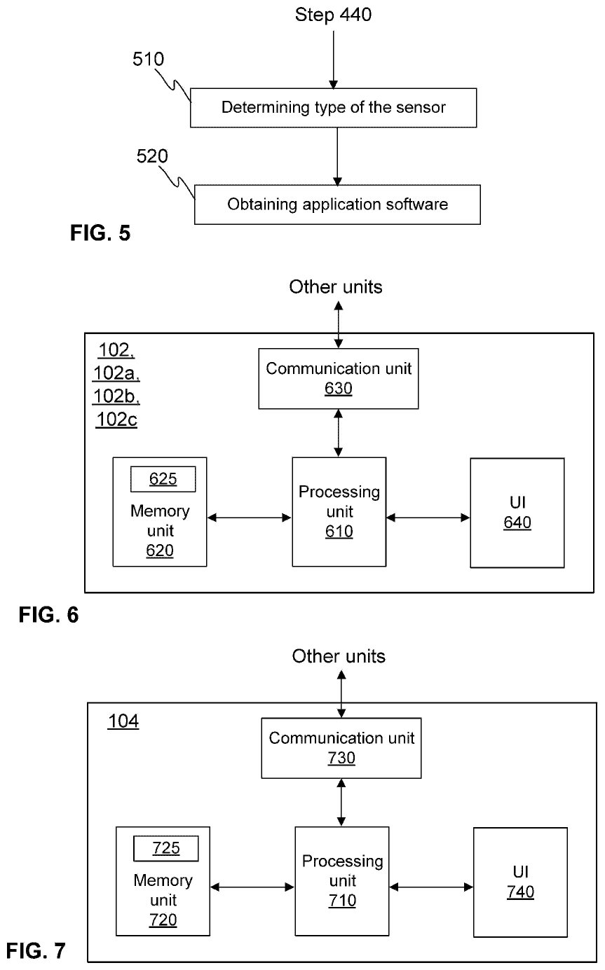

FIG. 5 illustrates schematically an example of the method, wherein after the assigning the sensor node 102b role at the step 440, the gateway device 104 may further determine 510 a type of the people conveyor related sensor 106 to which the node device 102b is connected. For example, the determination at the step 510 may be based on the obtained connection data, e.g. the identification information of the people conveyor related sensor 106 comprised in the obtained connection data. In other words, the type of the people conveyor related sensor 106 to which the node device 102, 102b is connected may be defined for example based on the identification information comprised in the obtained connection data. Alternatively or in addition, if the connection data is obtained by scanning the one or more communication interfaces of the node device 102 as discussed above, the determination at the step 510 may be based on the connection data obtained during the scanning. The gateway device 104 may further obtain 520 via a wireless update system an application software corresponding to the determined type of the people conveyor related sensor device 106 to which the node device 102, 102b is connected. In other words, in response to the determining the type of the people conveyor related sensor 106 to which the node device 102, 102b is connected, the gateway device 104 may further obtain via the wireless update system the application software corresponding to the identification information of the people conveyor related sensor device 106 to which the node device 102, 102b is connected. According to a non-limiting example, the wireless update system may be Over The Air Update (OTAP) system. The gateway device 104 may further provide to the node device 102 the obtained application software corresponding to the identification information of the people conveyor related sensor device 106 to which the node device 102, 102b is connected. After obtaining the application software, the node device 102, 102b may update its software in accordance with the obtained application software.

FIG. 6 schematically illustrates an example of components of the node device 102, 102a-102c. The node device 102, 102a-102c may comprise a processing unit 610 comprising one or more processors, a memory unit 620 comprising one or more memories, the communication interface unit 630 comprising one or more communication devices, and possibly a user interface (UI) unit 640. The mentioned elements may be communicatively coupled to each other with e.g. an internal bus. The memory unit 620 may store and maintain portions of a computer program (code) 625 and any other data, e.g. the obtained connection data, identification information of the peripheral device 104, 106, and/or the obtained application software. The computer program 625 may comprise instructions which, when the computer program 625 is executed by the processing unit 610 of the node device 102, 102a-102c may cause the processing unit 610, and thus the node device 102, 102a-102c to carry out desired tasks, e.g. the operations of the node device 102, 102a-102c and/or at least some of the method steps described above. The processing unit 610 may thus be arranged to access the memory unit 620 and retrieve and store any information therefrom and thereto. For sake of clarity, the processor herein refers to any unit suitable for processing information and control the operation of the node device 102, 102a-102c, among other tasks. The operations may also be implemented with a microcontroller solution with embedded software. Similarly, the memory unit 620 is not limited to a certain type of memory only, but any memory type suitable for storing the described pieces of information may be applied in the context of the present invention. As already discussed above the communication interface unit 630 provides one or more communication interfaces for communication with any other unit, e.g. the peripheral device 104, 106 of the people conveyor system 110, one or more other node devices 102, 102a-102c of the mesh network, and/or any other units. The communication interface unit 630 may comprise one or more communication devices e.g. at least one radio transceiver, at least one antenna, at least one communication port, etc. The user interface unit 640 may comprise one or more input/output (I/O) devices, such as buttons, keyboard, touch screen, microphone, loudspeaker, display and so on, for receiving user input and outputting information. The computer program 625 may be a computer program product that may be comprised in a tangible non-volatile (non-transitory) computer-readable medium bearing the computer program code 625 embodied therein for use with a computer, i.e. the node device 102, 102a-102c. The node device 102, 102a-102c may be powered by mains, e.g. by wall plug. Alternatively, the node device 102, 102a-102c may be powered by one or more batteries, i.e. the node device 102, 102a-102b may be battery operated.

FIG. 7 schematically illustrates an example of components of the gateway device 104. The gateway device 104 may comprise a processing unit 710 comprising one or more processors, a memory unit 720 comprising one or more memories, the communication interface unit 730 comprising one or more communication devices, and possibly a user interface (UI) unit 740. The mentioned elements may be communicatively coupled to each other with e.g. an internal bus. The memory unit 720 may store and maintain portions of a computer program (code) 725 and any other data, e.g. the obtained connection data, identification information of the peripheral device 106, and/or the obtained application software. The computer program 725 may comprise instructions which, when the computer program 725 is executed by the processing unit 710 of the gateway device 104 may cause the processing unit 710, and thus the gateway device 104 to carry out desired tasks, e.g. the operations gateway device 104 and/or at least some of the method steps described above. The processing unit 710 may thus be arranged to access the memory unit 720 and retrieve and store any information therefrom and thereto. For sake of clarity, the processor herein refers to any unit suitable for processing information and control the operation of gateway device 104, among other tasks. The operations may also be implemented with a microcontroller solution with embedded software. Similarly, the memory unit 720 is not limited to a certain type of memory only, but any memory type suitable for storing the described pieces of information may be applied in the context of the present invention. The communication interface unit 730 provides one or more communication interfaces for communication with any other unit, e.g. the node device 102, 102a of the people conveyor system 110, and/or any other units. The communication interface unit 730 may comprise one or more communication devices e.g. at least one radio transceiver, at least one antenna, at least one communication port, etc. The user interface unit 740 may comprise one or more input/output (I/O) devices, such as buttons, keyboard, touch screen, microphone, loudspeaker, display and so on, for receiving user input and outputting information. The computer program 725 may be a computer program product that may be comprised in a tangible non-volatile (non-transitory) computer-readable medium bearing the computer program code 725 embodied therein for use with a computer, i.e. the gateway device 104. The gateway device 104 may be powered by mains, e.g. by wall plug. Alternatively, the gateway device 104 may be powered by one or more batteries, i.e. gateway device 104 may be battery operated.

The above discussed monitoring system 100 and method enable easy and simple addition of new node devices 102 to the monitoring system 100 and/or replacement of faulty node devices of the monitoring system 100 with new node devices 102. The new node devices 102 may be generic node devices, e.g. generic radio dongles. The role assignment of the node device 102 may then be performed locally by the node device 102 itself and/or by the gateway device 104 by assigning, i.e. recognizing, the operation role of the node device for example by using a priori information obtained as a user input or by scanning of the peripheral devices 104, 106 connected to the node device 102 as described above.

The specific examples provided in the description given above should not be construed as limiting the applicability and/or the interpretation of the appended claims. Lists and groups of examples provided in the description given above are not exhaustive unless otherwise explicitly stated.

1. A monitoring system for monitoring a people conveyor system, wherein the monitoring system comprises a wireless mesh network comprising a plurality of node devices and one or more peripheral devices of the people conveyor system,
wherein a node device joining to the wireless mesh network is configured to:
obtain connection data representing a connection of the node device to a peripheral device of the people conveyor system, and
assign itself a sink node role, if the obtained connection data indicates a connection to a gateway device, wherein the gateway device is arranged to the people conveyor system, or
otherwise provide the obtained connection data to the gateway device, wherein the gateway device is configured to:
assign an operation role to the node device based on the obtained connection data, wherein the assigned role is:
a sensor node role, if the obtained connection data indicates a connection to a people conveyor related sensor device, wherein the people conveyor related sensor device is configured to obtain sensor data representing condition of the people conveyor system; or
a router node role, if the obtained connection data indicates that the node device is not connected to any peripheral device of the people conveyor system.

2. The monitoring system according to claim 1, wherein after the assigning the sensor node role to the node device, the gateway device is further configured to:
determine a type of the people conveyor related sensor device to which the node device is connected, and
obtain via a wireless update system an application software corresponding to the determined type of the people conveyor related sensor device to which the node device is connected.

3. The monitoring system according to claim 1, wherein the connection of the node device to the gateway device indicated by the obtained connection data is provided via a first type serial port connection, wherein the first type serial port connection is a Universal Serial Bus (USB) connection.

4. The monitoring system according to claim 1, wherein the connection of the node device to the people conveyor related sensor device indicated by the obtained connection data is provided via a second type serial port connection, wherein the second type serial port connection is an analog connection, a RS-232 connection, a RS-485 connection, an Inter-Integrated Circuit (I²C) connection, and/or a Serial Peripheral Interface (SPI) connection.

5. The monitoring system according to claim 1, wherein the node device is configured to obtain the connection data by scanning one or more communication interfaces of the node device.

6. The monitoring system according to claim 5, wherein the scanning comprises at least obtaining connection data via the one or more communication interface of the node device.

7. The monitoring system according to claim 5, wherein the scanning comprises providing request data via the one or more communication interfaces and obtaining the connection data via the one or more communication interfaces of the node device in response to the providing the request data.

8. The monitoring system according to claim 1, wherein the node device is configured to obtain the connection data as a user input.

9. The monitoring system according to claim 1, wherein the people conveyor related sensor device comprises a hydraulic sensor device, a door sensor device, a water presence sensor device, a light level sensor device, a human presence sensor device, a vibrating sensor device, a temperature sensor device, an energy meter device, or a universal asynchronous receiver-transmitter (UART) device.

10. The monitoring system according to claim 1, wherein the people conveyor system is an elevator system, an escalator system, or a moving walkway system.

11. A method for monitoring a people conveyor system, wherein the method comprises:
obtaining connection data representing a connection of a node device joining to a wireless mesh network to a peripheral device of the people conveyor system, and
assigning an operation role based on the obtained connection data, wherein the assigned role is:
a sink node role, if the obtained connection data indicates a connection to a gateway device, wherein the gateway device is arranged to the people conveyor system;
a sensor node role, if the obtained connection data indicates a connection to a people conveyor related sensor device, wherein the people conveyor related sensor device is configured to obtain sensor data representing condition of the people conveyor system; or
a router node role, if the obtained connection data indicates that the node device is not connected to any peripheral device of the people conveyor system.

12. The method according to claim 11, wherein after the assigning of the sensor node role, method further comprises:
determining a type of the people conveyor related sensor device to which the node device is connected, and
obtaining via a wireless update system an application software corresponding to the type of the people conveyor related sensor device to which the node device is connected.

13. The method according to claim 11, wherein the connection of the node device to the gateway device indicated by the obtained connection data is provided via a first type serial port connection, wherein the first type serial port connection is a Universal Serial Bus (USB) connection.

14. The method according to claim 11, wherein the connection of the node device to the people conveyor related sensor device indicated by the obtained connection data is provided via a second type serial port connection, wherein the second type serial port connection is an analog connection, a RS-232 connection, RS-485 connection, Inter-Integrated Circuit (I²C) connection, and/or Serial Peripheral Interface (SPI) connection.

15. The method according to claim 11, wherein the connection data is obtained by scanning one or more communication interfaces of the node device.

16. The method according to claim 15, wherein the scanning comprises at least obtaining connection data via the one or more communication interface of the node device.

17. The method according to claim 15, wherein the scanning comprises providing request data via the one or more communication interfaces and obtaining the connection data via the one or more communication interfaces of the node device in response to the providing the request data.

18. The monitoring system according to claim 11, wherein the connection data is obtained as a user input.

19. The method according to claim 11, wherein the people conveyor related sensor device comprises a hydraulic sensor device, a door sensor device, a water presence sensor device, a light level sensor device, a human presence sensor device, a vibrating sensor device, a temperature sensor device, an energy meter device, or a universal asynchronous receiver-transmitter (UART) device.

20. The method according to claim 11, wherein the people conveyor system is an elevator system, an escalator system, or a moving walkway system.

21. A people conveyor system comprises the monitoring system according to claim 1.
